(19) United States
(12) Patent Application Publication
(10) Pub. No.: US 2010/0092372 A1
(43) Pub. Date: Apr. 15, 2010

(54) HALIDE ION CONTROL OF SEED MEDIATED GROWTH OF ANISOTROPIC GOLD NANOPARTICLES

(75) Inventors: Chad A. Mirkin, Wilmette, IL (US); Jill E. Millstone, Jacksonville, FL (US); Wei Wei, Evanston, IL (US); Matthew R. Jones, LaMesa, CA (US); Hyojong Yoo, Los Alamos, NM (US)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: NORTHWESTERN UNIVERSITY, Evanston, IL (US)

(21) Appl. No.: 12/469,394

(22) Filed: May 20, 2009

Related U.S. Application Data
(60) Provisional application No. 61/055,067, filed on May 21, 2008.

(51) Int. Cl. C01B 9/06; C01G 7/00; C01B 7/14

(52) U.S. Cl. 423/491; 977/700; 977/810

(57) ABSTRACT

Methods of forming nanoprisms or nanorods from gold seed particles by adding controlled amounts of iodide ion to the growth solution are disclosed.

### CROSS-REFERENCE TO RELATED APPLICATIONS

This application claims the benefit of U.S. Provisional Application No. 61/055,067, filed May 21, 2008, the disclosure of which is incorporated by reference herein in its entirety.

### STATEMENT OF GOVERNMENT SUPPORT

This invention was made with U.S. government support under Office of Naval Research (ONR) Grant No. N00014-06-1-0079. The government has certain rights in this invention.

### BACKGROUND

Efforts to generate nanoparticles of various sizes and shapes have produced a library of materials that allow one to observe the close relationship between nanostructure properties and physical architecture. These structure-dependent behaviors are of enormous interest for applications in photonics (Fromm, et al., J. Chem. Phys. 124: 061101-1/4 (2006) and Maier, et al., App. Phys. Lett. 81:1714-1716 (2002)), catalysis (Narayanan, et al., Nano Lett. 4:1343-1348 (2004), nanoelectronics (Gudiksen, et al., Nature, 415:617-620 (2002)), and therapeutics (Hirsch, et al., Proc. Natl. Acad. Sci. USA, 100:13549-13554 (2003); Jain, et al., J. Phys. Chem. B, 110:7238-7248 (2006); and Rosi, et al. Science, 312:1027-1030 (2006)).

For colloidal nanorods and nanoprisms made of gold, the preferred synthetic route is a seeding methodology. However, it is well known that the methods used to synthesize particles are often irreproducible and difficult to control (Sau, et al., J. Am. Chem. Soc., 126:8648-8649 (2004); Lofton, et al., Adv. Funct. Mater., 15:1197-1208 (2005); and Smith, et al., Langmuir, 24:644-649 (2008)). On the one hand, researchers have pointed to the importance of the surfactant (cetyltrimethylammonium bromide, CTABr), including surfactant concentration, counterion, alkyl chain length, and even chemical manufacturer, on the yield and morphology of the resulting colloids (Sau, et al., J. Am. Chem. Soc., 126:8648-8649 (2004); Smith, et al., Langmuir, 24:644-649 (2008); and Gao, et al., Langmuir, 19:9065-9070 (2003)). On the other hand, researchers have pointed to synthetic additives such as metal or halide ions as major factors in directing crystal growth (Nikoobakht, et al., Chem. Mater., 15:1957-1962 (2003); Rai, et al., Langmuir, 22:736-741 (2006); and Ha, et al., J. Phys. Chem. C, 111:1123-1130 (2007)).

However, a strong connection does not exist between these observations, and thus the utility of these methods has been limited by the resulting difficulty in producing and controlling the final nanoparticle morphology. For example, Rai, et al. report the suppression of gold nanoprism growth with the addition of iodide ion (I⁻), whereas Ha et al. report the exact opposite and show that the presence of I⁻ promotes nanoprism formation (Rai, et al., Langmuir, 22:736-741 (2006) and Ha, et al., J. Phys. Chem. C, 111:1123-113 (2007)). In recent work, it was also shown that only CTABr obtained from certain manufacturers could produce nanorods, whereas other CTABr produced only pseudo-spherical particles (Smith, et al., Langmuir, 24:644-649 (2008)). Therefore, there is a need for methods that reliably control nanoparticle morphology, as particle morphology influences the optical, mechanical, fluidic, catalytic, and other properties of the particles. Being able to control morphology and to make desired morphologies with the desired properties in high yield is important in industrial applicability of nanoparticles.

### SUMMARY

Disclosed herein are methods of preparing nanoparticles having a desired morphology by controlling the amount of iodide ion in the reaction mixture. Different amounts of iodide ion result in different morphologies of the formed nanoparticle.

Thus, one aspect provides a method of preparing nanoprisms comprising admixing gold seed particles having a diameter of about 4 to about 10 nm; an iodide ion source; and a growth solution comprising a gold ion source, a reducing agent, a surfactant, and a base under conditions sufficient to form the nanoprisms, wherein the iodide ion source and the surfactant are different, the nanoprisms are the major morphology formed, and the iodide ion concentration is at least 50 μM. The nanoprisms formed can have a plasmon resonance greater than 1000 nm. In some cases, the resulting nanoprisms can be essentially free of spheres and rods.

Also provided herein are gold nanoprisms having iodide ion on the (111) face and having a plasmon resonance of at least 1000 nm. These nanoprisms can be prepared by the methods disclosed herein.

Another aspect provides a method preparing nanorods comprising admixing gold seed particles having a diameter of about 4 to about 10 nm; an iodide ion source; and a growth solution comprising a gold ion source, a reducing agent, a surfactant, and a base under conditions sufficient to form the nanorods, wherein the iodide ion source and the surfactant are different, the nanorods are the major morphology formed, and the iodide ion concentration is about 2 μM to about 10 μM. In some cases, the resulting nanorods can be essentially free of spheres and nanoprisms.

For the disclosed methods herein, the iodide concentration can be 50 μM to about 75 μM. The iodide ion source can be sodium iodide, potassium iodide, lithium iodide, or mixtures thereof. The gold ion source can be hydrogen tetrachloroaurate or a salt thereof. The reducing agent can be ascorbic acid. The surfactant can be tetrabutylammonium bromide, dodecyldimethylammonium bromide, cetyltrimethylammonium bromide, or mixtures thereof. In some cases, the surfactant is cetyltrimethylammonium bromide. The base can be sodium hydroxide.

The disclosed methods can further comprise preparing gold seed nanoparticles by reducing a gold ion source with sodium borohydride.

### BRIEF DESCRIPTION OF THE DRAWINGS

FIG. 1. (A) UV-vis-NIR spectra of nanoparticles made using various concentrations of I⁻, and corresponding TEM images of pseudo-spherical nanoparticles (B), nanorods (C), and nanoprisms (D).

FIG. 2. XPS spectra (A) of gold nanoprisms; arrow indicates I⁻ signal; (B) centered at binding energy of I⁻ and taken from nanoprisms, rods, and pseudo-spherical nanoparticles. Spectra indicate I⁻ only on nanoprisms.

FIG. 3. UV-vis-NIR spectra of nanoparticles produced using five different CTABr batches from different suppliers. Each CTABr was used as received from the manufacturer.

FIG. 4. UV-vis-NIR spectra of nanoprism solutions made using 50 μM concentrations of LiI, NaI, and KI. Each batch shows the characteristic dipole and quadrupole plasmon resonances of Au nanoprisms.

### DETAILED DESCRIPTION

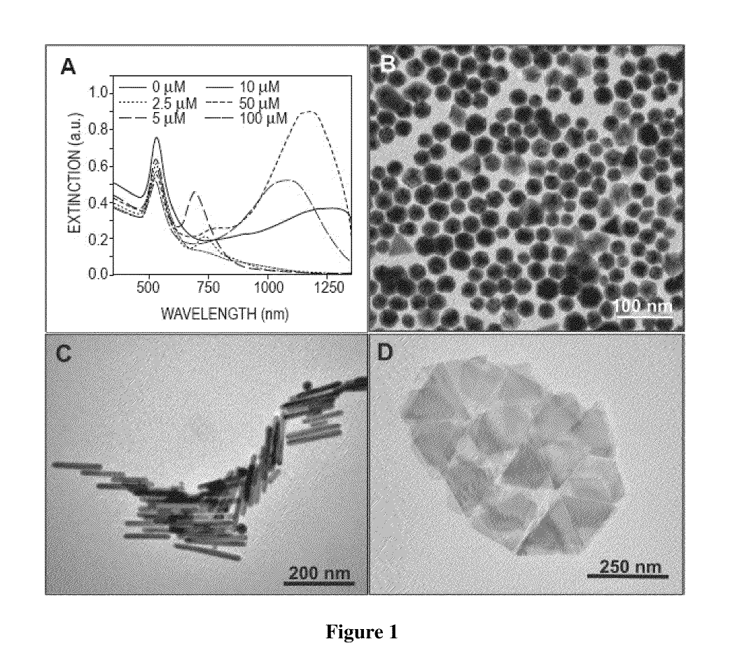

Disclosed herein are methods for the controlled synthesis of gold nanorods, nanoprisms, and nanospheres. These methods provide a means for controllable and consistent preparation of nanoparticles having desired morphology and comprise a unified framework that encompasses and explains previously reported results regarding the role of synthetic additives and the cationic surfactant, CTABr. The term “nanoprism” as used herein refers to a metal composition that exhibits prismatic properties and typically has a triangular shape that can optionally have rounded or truncated corners (see FIG. 1D). Nanoprisms are anisotropic. “Nanorods,” as used herein are materials that have a rod-like structure, as seen in FIG. 1C, and are anisotropic. “Nanospheres,” or alternatively “spheres” are materials having a sphere-like structure and are isotropic (see FIG. 1B).

The methods and reaction conditions necessary to consistently produce rods, prisms, and spheres are described herein and address some of the lore surrounding these syntheses and the widely varied reports on methods for controlling morphologies of nanoparticles. In particular, the role of iodide ion (I⁻) in determining the morphology of the nanoparticles formed and an possible explanation for the diverse, inconsistent and often contradictory prior conclusions on the determining effects of various conditions are provided.

A preferred synthetic method for preparing colloidal nanorods and nanoprisms is a seed-mediated growth method. In a typical seed-mediated gold nanoparticle process, small gold seed nanoparticles (diameters of about 4 nm to about 6 nm) are prepared by sodium borohydride (NaBH₄) reduction of a gold ion source, such as the salt HAuCl₄, and used in a subsequent three-step growth of these particles in an aqueous solution containing a surfactant (typically CTABr), gold ions (HAuCl₄.3H₂O), reducing agent (ascorbic acid), and a base, such as NaOH; together termed “growth solution” (Busbee, et al., Adv. Mater., 15:414-416 (2003) and Millstone, et al. J. Am. Chem. Soc., 127:5312-5313 (2005)). The growth solution is typically used in a three step process of increasing amounts of solution to seed particles to form the nanomaterial of interest (e.g., nanorod, nanoprism, or nanosphere). A detailed description of this step-growth process can be found in International Patent Publication No. WO 2006/099312, which is incorporated by reference in its entirety herein. These prior disclosures regarding preparation of nanoparticles of various morphologies are difficult to reproduce and often lead to different major morphologies formed under nominally identical conditions.

During the course of investigating methods for consistent formation of nanoparticle morphologies using seed-mediated growth, I⁻ was observed on the (111) faces of the formed nanoprisms, using X-ray Photoelectron Spectroscopy (XPS) analysis, despite the fact that no apparent source of I⁻ was used during the syntheses of these nanoprisms.

In order to understand the origin of the I⁻ in this synthesis, inductively coupled plasma mass spectrometry (ICP-MS) was used to analyze I⁻ concentration in the CTABr, NaOH, HAuCl₄, ascorbic acid, sodium citrate, and NaBH₄ used to prepare the nanoparticles (Table 1).

TABLE 1

| | | Iodide concentration |
|---|---|---|
| | | in 0.01% |
| | Manufacturer, Purity, | aqueous CTAB |
| Chemical Reagent | Batch Number | solution (nM) |
| HAuCl₄ | Aldrich, 99.99% | — |
| Ascorbic Acid | Aldrich, 99+% | — |
| NaOH | Aldrich, 97% | — |
| NaBH₄ | Aldrich, 99.995% | — |
| Trisodium Citrate | Aldrich, 98% | — |
| CTABr #1 | Sigma, 99%, #095K0187 | — |
| CTABr #2 | Aldrich, 95%, #06901CD | 6.3 |
| CTABr #3 | Aldrich, 95%, #0590BH | — |
| CTABr #4 | Aldrich, 95%, #06602KC | — |
| CTABr #5 | GFS Chemical, 98%, #P452770 | 15.7 |
| CTABr #6 | Recrystallized CTABr #2 | — |

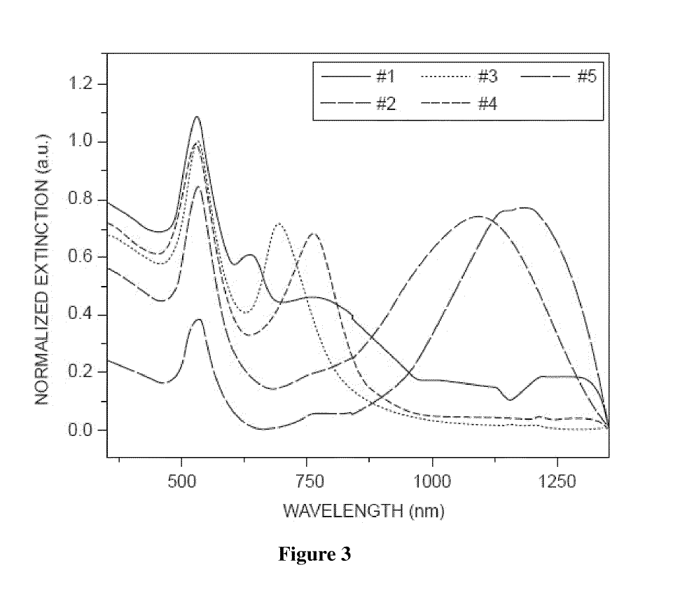

Only in the case of the CTABr was the presence of iodide detectable (ICP-MS detection limit for I⁻ is about 1 ppb under the conditions studied). Five additional batches of CTABr from varying manufacturers and of varying purities were analyzed. Interestingly, only certain CTABr batches contained I⁻ (see Table 1). Each of the five CTABr batches was used in repeated trials of the seed-mediated synthesis. In the cases of CTABr that contained detectable traces of I⁻ (#2, #5), nanoprisms formed. In the cases of the other three CTABr's, two produced various concentrations of nanorods, and one produced only pseudo-spherical nanoparticles (#1) (FIG. 3). From these data, it was hypothesized that the variation of seed-mediated syntheses based on CTABr may originate from the variability of an I⁻ impurity.

In order to determine whether I⁻ is the impurity responsible for the observed nanorod, nanoprism, and nanosphere results, CTABr (#2) was recrystallized using literature methods (Dearden, et al., J. Phys. Chem., 91:2404-2408 (1987)). The recrystallized product was analyzed by ICP-MS, and no I⁻ could be detected (#6). This pure CTABr was then used to analyze the absolute concentrations of I⁻ necessary to produce a given shape morphology using seed-mediated methodology. It is important to note that others have concluded that use of CTABr from different manufactures leads to different results, but did not identify, or even consider, the role of I⁻ (Smith, et al., Langmuir, 24:644-649 (2008)).).

In a typical experiment of the methods disclosed herein, I⁻ was introduced into the synthesis by adding aliquots of a NaI stock solution (0.1 M) directly into the CTABr prior to synthesis. Iodide concentrations of 0, 2.5, 5, 10, 50, and 100 μM were investigated, and the same nanoparticle seed batch was used to initiate each reaction, in order to provide a control for the effects of the seed nanoparticle morphology.

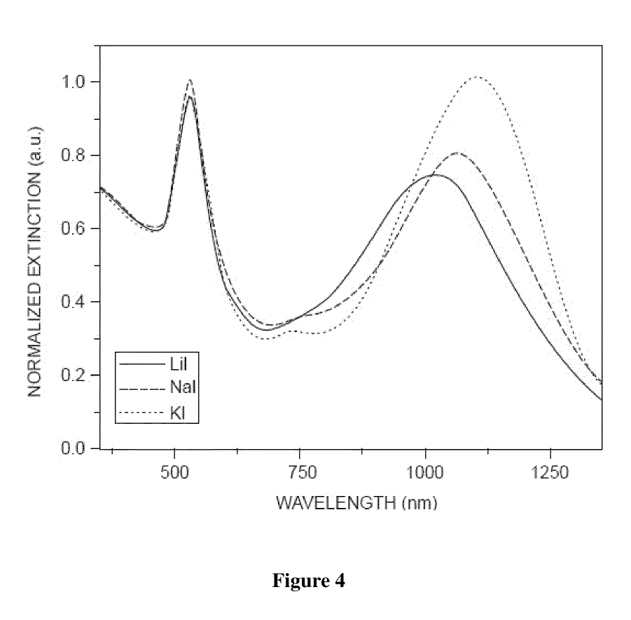

UV-vis-NIR spectra of the resulting solutions show a remarkable dependence of nanoparticle morphology on the presence of I⁻ (FIG. 1A). With no I⁻ in solution, little anisotropic nanoparticle formation (<10%) is observed. However, at very low concentrations of I⁻ (2.5 and 5 μM), a large population of nanorods can be observed (about 45% yield before purification). As the concentration of I⁻ increases (>10 μM), a mixture of nanoparticle morphologies is observed including rod, prism, and sphere morphologies. At 50 μM I⁻ concentration, nanoprisms form in high yield as indicated by the strong dipole and quadrupole modes in the extinction spectrum (about 65% yield before purification). However, at higher concentrations of I⁻ (>75 μM), plate-like growth continues, but produces rounded, triangular and disk-like particles. This analysis, based on the bulk characterization afforded by UV-vis-NIR spectroscopy, was confirmed by TEM. (FIGS. 1B, C, and D). Interestingly, these results were not dependent on the counterion of I⁻. In addition to NaI, KI and LiI produced similar results (FIG. 4).

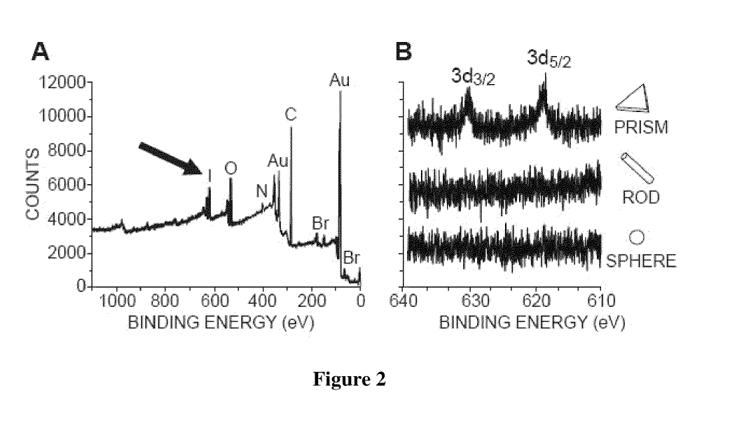

To investigate the role of the I⁻ in these syntheses, nanoparticle solutions were deposited on silicon substrates for analysis by XPS. Interestingly, in all cases (both experiments using CTABr directly from the manufacturer and in experiments using purified CTABr and controlled introduction of I⁻), I⁻ was only observed on samples composed of nanoprisms; samples comprised of rods and/or spheres did not exhibit detectable I⁻ signals by XPS (FIG. 2). These results strongly suggest that I⁻ is bound to the (111) crystal facet of the nanoprisms, which compose their broad triangular faces (Millstone, et al., Adv. Funct. Mater., 16:1209-1214 (2006)). It is well known that halide ions adsorb on gold surfaces, and that their binding energies scale with polarizability (I⁻>Br⁻>Cl⁻) and crystal facet ((111)>(110)>(100)) (Magnussen, Chem. Rev., 102:679-726 (2002)). In previous reports, it has been postulated that the I⁻ preferentially binds to the (111) facet of a growing nanoparticle, and prevents reaction at that surface (Ha, et al., J. Phys. Chem. C, 111:1123-1130 (2007)). However, reports describing this mechanism also pointed to competing shape directing factors such as pH, temperature, and surfactant counterion, and do not identify the original source of the I⁻.

As discovered in the investigations disclosed herein, under normal synthetic conditions, I⁻ is the dominant shape directing moiety. These results are consistent with the preferential adsorption of I⁻ on the (111) crystal facet, and further these results suggest that at elevated concentrations of I⁻ (>75 μM), the anion can also interact with the higher energy crystals facets to prevent the growth of fully formed triangular or hexagonal particles (FIG. 1A). Interestingly, at low concentrations of I⁻, nanorods are the dominant anisotropic nanoparticle product without any changes to surfactant concentration, counterion, pH, or temperature. However, in the case of nanorods, it has been shown previously that the surface along the long axis of the particle is composed of either (100) or (110) crystal facets (Murphy, et al., Inorg. Chem., 45:7544-7554 (2006)), and that the particle grows from the (111) crystal facets at its two ends. Because no I⁻ is detectable from monolayers of these particles by XPS or in the CTABr used to prepare them (i.e., I⁻ concentration in the CTABr is below the ICP-MS limit of detection and the concentration of I⁻ from the nanorods is below the detection limit of XPS), it is reasonable to postulate that I⁻ is not playing a suppressive role in the formation of these particles.

Studies exist that describe the role of halide ions in the formation and morphology of micelles in CTABr solutions above the critical micelle concentration, and these reports may be relevant in understanding the role of halide ions at these low concentrations (Maiti, et al. J. Phys. Chem. B, 111:14175-14185 (2007) and Pi, et al., J. Colloid Interface Sci., 306:405-410 (2007)). A mechanism based on the shape of the CTABr micelle echoes early theories on nanorod formation which suggested that metal ion reduction occurs only at the ends of the rod-like, surfactant micelle (Nikoobakht, et al., Chem. Mater, 15:1957-1962 (2003) and Busbee, et al., Adv. Mater., 15:414-416 (2003)). The results provided herein are consistent with this theory. While the role of I⁻ at low concentrations remains unclear, it is apparent from the experiments reported herein that the final nanoparticle morphology does not depend predominantly on the structure of the original seed, because the same nanoparticle seeds have been used in all syntheses.

For these studies, the original conditions reported by Brown et al., Chem. Mater., 12:306-313 (2000), Jana, et al., J. Phys. Chem. B, 105:4065-4067 (2001), and Millstone, et al., J. Am. Chem. Soc., 127:5312-5313 (2005) have been used in an attempt to present a self-consistent protocol for the production of gold nanospheres, nanorods, and nanoprisms using the seeding methodology. Importantly, these results do not depend on CTABr itself, but rather demonstrate the critical role of iodide ion in these syntheses. Taken together, this approach represents the first synthetic method for nanoprisms, nanorods, and spherical nanoparticles made of gold that can be deliberately and consistently controlled based upon I⁻ concentration.

### Components of the Growth Solution

A growth solution is used to prepare the anisotropic materials disclosed herein. The growth solution comprises a gold ion source, a surfactant, a reducing agent, and a base.

The gold ion source is a gold salt. Gold salts for use in the disclosed method include, but are not limited to, gold(III) chloride, and derivatives, hydrates, and solvates thereof. A specific gold salt contemplated is hydrogen tetrachloroaurate (HAuCl₄).

Surfactants useful in the present method include, but are not limited to, (a) ammonium salts having at least one and up to four substituents having at least four carbons and (b) alkyl pyridinium salts. Specific examples are, but are not limited to, tetrabutylammonium bromide (TBAB), dodecyldimethylammonium bromide (DDAB), cetyltrimethylammonium bromide (CTAB). The counterion of the ammonium or alkyl pyridinium salt can be acetate, halide (excluding iodide), pivolate, glycolate, lactate, and the like. The concentration of surfactant in a growth solution typically is about 80% saturated up to 100% saturated, at 25° C. A preferred concentration of the surfactant in a growth solution is at least 90% saturated.

Bases for use in the disclosed method include, but are not limited to, sodium hydroxide, potassium hydroxide, ammonium hydroxide, magnesium hydroxide, sodium carbonate, sodium bicarbonate, and the like. A preferred base is sodium hydroxide.

Reducing agents for use in the disclosed methods include, but are not limited to, ascorbic acid, sodium borohydride, 2-mercaptoethanol, dithiothreitol (DTT), hydrazine, lithium aluminum hydride, diisobutylaluminum hydride, oxalic acid, Lindlar catalyst, sulfite compounds, stannous compounds, ferrous compounds, sodium amalgam, and the like.

The resulting gold nanoprisms or nanorods can be further purified to separate smaller nanoparticles from nanoprisms having the desired dimensions. In one embodiment, this purification is performed by filtration. Typically, the filtration is accomplished using an aluminum oxide filter having 100 nm pores, for example (Whatman, Florham Park, N.J. USA). Other means of purification or removal of small nanoparticles from the reaction solution can be employed. A nonlimiting example includes centrifugation.

The morphology of the material formed in the methods disclosed herein comprises one major morphology, e.g., no other single morphology is formed in a greater amount than that of the nanoprism or nanorod, respectively, as dependent upon high iodide ion concentration (nanoprism) or low iodide ion concentration (nanorod). In some cases, the nanorod or nanoprism morphology comprises at least 50% of total amount of morphologies formed. In preferred cases, the nanorod or nanoprism comprises at least 60%, at least 70%, or at least 80% of the total amount of morphologies formed. A nanoparticle sample that is one morphology and “essentially free” of other morphologies is one which has up to 10%, but preferably less than 5%, of those other morphologies.

Additional aspects and details of the invention will be apparent from the following examples, which are intended to be illustrative rather than limiting.

### Examples

### Materials

Hydrogen tetrachloroaurate trihydrate (HAuCl₄.3H₂O, 99.9%), sodium borohydride (NaBH₄, 99.995%), sodium hydroxide (NaOH, 99.998%), L-ascorbic acid (99%), trisodium citrate (99%), potassium iodide (99%), sodium iodide (99%), lithium iodide (99%) were obtained from Aldrich and used as received. Cetyltrimethlyammonium bromide (CTABr) was ordered from various manufacturers with various purities, see Table S1.

### Preparation and Recrystallization of Cetyltrimethylammonium Bromide (CTABr)

For all experiments, 0.05M CTABr was prepared by dissolving 2.733 g of CTABr in 150 mL of NANOpure™ (18.1 MΩ) water. The solution was sealed with parafilm and heated until it appeared crystal clear. This sealed solution was then sonicated for about 30 s, to ensure that all CTABr was dissolved. The solution was cooled to room temperature before use in subsequent syntheses (about 2 h).

To purify CTABr, 10 g samples of CTABr (SigmaUltra, Aldrich Chemical Company) were dissolved in a warm ethanol/water mixture (10:1) (about 150 mL) and allowed to recrystallize at 4° C. The crystals were isolated by Buchner filtration, washed with ethyl ether, and dried in a vacuum oven at 55° C. for 6 h. The process was then repeated 2 additional times for each 10 g sample, so that CTABr had been recrystallized three times before being used in the experiments.

### Synthesis of Anisotropic Gold Nanoparticles

In a typical experiment, all glassware was washed with aqua regia (3:1 ratio by volume of HCl and HNO₃), and rinsed copiously with NANOpure™ (18.1 MΩ) water. Gold nanoparticle seeds were prepared by reducing 1 mL of 10 mM HAuCl₄ with 1 mL of 100 mM NaBH₄ while stirring vigorously. The reduction was done in the presence of 1 mL of 10 mM sodium citrate and 36 mL of fresh, NANOpure™ water. Upon addition of the NaBH₄, the solution turned a reddish-orange color and was allowed to continue stiffing for one minute. The resulting mixture was aged for 2-6 hours in order to allow the hydrolysis of unreacted NaBH₄. The gold nanoparticle seeds exhibited a plasmon resonance peak at 500 nm, and had an average diameter of 5.2±0.6 nm.

After the aging period, three growth solutions were prepared for the seed-mediated growth step. The first two solutions (1 and 2) contained 0.25 mL of 10 mM HAuCl₄, 0.05 mL of 100 mM NaOH, 0.05 mL of 100 mM ascorbic acid, and 9 mL of the prepared CTABr solution. The final growth solution (designated 3), contained 2.5 mL of 10 mM HAuCl₄, 0.50 mL of 100 mM NaOH, 0.50 mL of 100 mM ascorbic acid, and 90 mL of the prepared CTABr solution. For syntheses involving the addition of iodide, controlled amounts of KI, NaI, or LiI were added to the original CTABr solutions such that growth solutions 1, 2 and 3 were at the same iodide concentration. Final concentrations of 100, 75, 50, 25, 10, and 2.5 μM iodide were prepared by adding aliquots of a 0.1 M solution of either KI, NaI, or LiI to the previously prepared 150 mL CTABr solutions (prior to dissolving procedure by heating).

In all cases, particle formation was initiated by adding 1 mL of seed solution to growth solution 1. The solution was gently shaken, and then 1 mL of growth solution 1 was immediately added to 2, 2 was shaken, and all of the resulting growth solution was added to 3. After the addition, the color of 3 changed from clear to deep magenta-purple over a period of 30 minutes for all preparations.

### ICP-MS Analysis

Inductively Coupled Plasma-Mass Spectrometry (ICP-MS; Thermo-Fisher) analysis was performed using an Argon gas generated plasma and a 5% NH₄OH matrix (Bu, et al. Anal. At. Spectrom., 18:1443-1451 (2003)). Experimental ICP values were compared to a standard curve generated using standards prepared from NaI by weight (1, 2, 5, 10, 25, 50, 100, and 200 ppb by weight) and dissolved in the NH₄OH matrix. A 1 ppb Indium internal standard was used in all measurements.

### XPS Analysis

Particle solutions were washed by centrifugation at 8 krpm for 3 min, and nanoparticle pellets were resuspended in 1 mL of NANOpure™ water. This process was repeated three times, and the final pellet was resuspended in 200 μL of NANOpure™ water. Two 10 μL droplets of this mixture were applied to a silicon substrate (substrate was cleaned by sonication in ethanol, rinsed with acetone, and finally rinsed with water) and allowed to dry in a vacuum-sealed desiccator. The substrate was then rinsed again with water and dried under a stream of N₂.

After preparation, the sample was transferred to an analysis chamber equipped with an X-ray photoelectron spectrometer (XPS, Omicron). An aluminum Kα (1486.5 eV) anode with a power of 200 W (20 kV) was used. XPS spectra were gathered using a hemispherical energy analyzer operated at a pass energy of 70.0 eV for survey scans and 20.0 eV for elemental analysis. Binding energies were referenced to the Au_{4f} peak at 84.0 eV for pure Au.

### UV-vis-NIR Spectrophotometry and TEM Analysis

The seed mediated growth reaction of the nanoparticles was characterized by ultraviolet-visible-near infrared spectroscopy (UV-Vis-NIR) using a Cary 5000 spectrophotometer, baselined to the spectrum of NANOpure™ water. All nanostructures were characterized using a Hitachi-8100 transmission electron microscope (TEM) at 200 kV.

### Elucidating the Detection of Iodide by XPS

In the experiments described herein, the presence of iodide on the surface of gold nanoprisms was detected by XPS which is likely a result of the (111) crystal facet concentrating iodide ion out of the reaction solution. This was confirmed by ICP-MS that the highest concentration of iodide in any CTABr analyzed was likely below the detection limit of XPS. However, to further evaluate the possibility that CTABr observed on the surface of the nanoprisms was a result of the high iodide in the CTABr itself, XPS spectra of pure powders from 3 different CTABr batches were analyzed. As expected, no iodide was observed in any sample.

### Role of Other Halide Ions

The controlled nanoparticle growth seen using I⁻ was not observed when using either Br⁻ or Cl⁻ sodium salts at the concentrations studied. For Br, these results are easily understandable because Br is already present in large quantities in the CTABr, and adding more Br⁻ does not change the effective chemistry of the reaction. In the case of chloride, it has a weaker binding affinity for the gold surface as compared to Br⁻ or I⁻ and is unable to effectively block growth in a particular crystal direction (Magnussen, Chem. Rev., 102:679-726 (2002)).

The foregoing describes and exemplifies the invention but is not intended to limit the invention defined by the claims which follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein without departing from the concept, spirit and scope of the invention. More specifically, it will be apparent that certain agents which are both chemically and physiologically related may be substituted for the agents described herein while the same or similar results would be achieved.

1. A method of preparing nanoprisms comprising
admixing gold seed particles having a diameter of about 4 to about 10 nm; an iodide ion source; and a growth solution comprising a gold ion source, a reducing agent, a surfactant, and a base under conditions sufficient to form the nanoprisms,
wherein the iodide ion source and the surfactant are different, the nanoprisms are the major morphology formed, and the iodide ion concentration is at least 50 μM.

2. The method of claim 1, wherein the iodide ion concentration is 50 μM to about 75 μM.

3. The method of claim 1, wherein the nanoprism (111) face has iodide ion bound thereto.

4. The method of claim 1, wherein the iodide ion source comprises sodium iodide, potassium iodide, lithium iodide, or mixtures thereof.

5. The method of claim 1, wherein the gold ion source comprises hydrogen tetrachloroaurate (HAuCl4) or a salt or hydrate thereof.

6. The method of claim 1, wherein the reducing agent comprises ascorbic acid.

7. The method of claim 1, wherein the surfactant comprises tetrabutylammonium bromide, dodecyldimethylammonium bromide, cetyltrimethylammonium bromide, or mixtures thereof.

8. The method of claim 7, wherein the surfactant is cetyltrimethlyammonium bromide.

9. The method of claim 1, wherein the base comprises sodium hydroxide.

10. The method of claim 1, wherein the nanoprisms have a plasmon resonance of greater than about 1000 nm.

11. The method of claim 1, wherein the nanoprisms are essentially free of spheres or rods.

12. A method of preparing nanorods comprising
admixing gold seed particles having a diameter of about 4 to about 10 nm; an iodide ion source; and a growth solution comprising a gold ion source, a reducing agent, a surfactant, and a base under conditions sufficient to form the nanorods,
wherein the iodide ion source and the surfactant are different, the nanorods are the major morphology formed, and the iodide ion concentration is about 2 μM to about 10 μM.

13. The method of claim 12, wherein the iodide ion source comprise sodium iodide, potassium iodide, lithium iodide, or mixtures thereof.

14. The method of claim 12, wherein the gold ion source comprises hydrogen tetrachloroaurate (HAuCl4) or a salt or hydrate thereof.

15. The method of claim 12 wherein the reducing agent comprises ascorbic acid.

16. The method of claim 12, wherein the surfactant comprises tetrabutylammonium bromide, dodecyldimethylammonium bromide, cetyltrimethylammonium bromide, or mixtures thereof.

17. The method of claim 16, wherein the surfactant is cetyltrimethlyammonium bromide.

18. The method of claim 12, wherein the base comprises sodium hydroxide.

19. The method of claim 12, wherein the nanorods are essentially free of nanoprisms and spheres.

20. The method of claim 1, further comprising preparing the gold seed particles by reducing a gold ion source with sodium borohydride.

21. A gold nanoprism having iodide ion on the (111) face and having a plasmon resonance of at least 1000 nm.
